(19) United States
(12) Patent Application Publication
(10) Pub. No.: US 2006/0130962 A1
(43) Pub. Date: Jun. 22, 2006

(54) Containers

(76) Inventor: Wayne John Harrison, Manukau City (NZ)

Correspondence Address: STETINA BRUNDA GARRED & BRUCKER, 75 ENTERPRISE, SUITE 250, ALISO VIEJO, CA, 92656, US

(21) Appl. No.: 11/319,986

(22) Filed: Dec. 28, 2005

Related U.S. Application Data
(63) Continuation-in-part of application No. 09/981,388, filed on Oct. 17, 2001, now abandoned.
Application No. 09/981,388 is a continuation-in-part of application No. 09/381,435, filed on Sep. 16, 1999, now abandoned.

(51) Int. Cl. B31F 1/22

(52) U.S. Cl. 156/205; 156/272.6

(57) ABSTRACT

The present invention relates to a method of forming a laminated material comprising the steps of corrugating a paper sheet, and applying a liner to one or both sides of the corrugated sheet, wherein the liner is a pre-made laminate of a paper backing and plastic film which is metalized on one side and corona or chemically treated on the other side. A laminating apparatus for use in the above method is also described herein, which includes a means for feeding out a paper sheet and a liner to a set of corrugating rollers, the liner being a pre-formed laminate of paper and plastics film, and means for uniting the paper sheet and liner immediately subsequently to the corrugation of the paper sheet.

### CROSS-REFERENCE TO RELATED APPLICATIONS

The present application is a continuation-in-part of U.S. application Ser. No. 09/981,388 entitled IMPROVEMENTS IN OR RELATING TO CONTAINERS filed Oct. 17, 2001, which is a continuation-in-part of U.S. application Ser. No. 09/381,435 entitled IMPROVEMENTS IN OR RELATING TO CONTAINERS filed Sep. 16, 1999 and now abandoned, which claims priority to PCT/NZ98/00036 entitled PROCESS AND DEVICE FOR MAKING A CORRUGATED SHEET FOR CONTAINERS filed on Mar. 16, 1998.

### STATEMENT RE: FEDERALLY SPONSORED RESEARCH/DEVELOPMENT

Not Applicable

### BACKGROUND

1. Field of the Invention

This invention relates to containers and in particular containers used for transportation and storing chilled or frozen foods. Preferably the present invention may be employed to create a corrugated product which is laminated with a metalized liner to improve the insulation properties of the corrugated product produced. Preferably this corrugated product may be produced in a single continuous ‘in-line’ process which both corrugates a stock card material and laminates the metalized liner immediately subsequent to corrugation.

2. Description of the Prior Art

Chilled or frozen foods are commonly packed in insulated containers. In one example expanded foams are commonly used for providing insulation properties. The material however has low impact resistance and is not generally regarded as having sufficient structural integrity for packaging applications and as a result the foam is often protected by an outside box. In addition, expanded foams are not approved for food contact applications and food within such containers consequently needs to be bagged or wrapped.

Metal foils are also used in packaging situations to provide insulation properties.

The use of expanded foam insulation materials in packaging is not regarded as ideal because the material is bulky and in addition there are recognized disposal problems.

Metal foils present manufacturing problems, additional costs, physical properties are not compatible with machinery and standard processing techniques and consequently tend to be used only for smaller higher value items.

As an alternative packaging material, cardboard has good natural insulation qualities, which can be improved if a board is laminated, lamination also improving strength. However, existing technology does not allow a laminated cardboard product which includes layers of metalized foil to be easily provided. In this instance sheet laminating machines are normally used.

WO 90/06222 (Olvey) and EPO 319252 (Brownlee) describe types of sheet lamination machines. The teachings of these references are confined to plastic film, standing alone, being adhered to a pre-corrugated product via a molten polymer.

A problem identified by the applicants with sheet laminating machinery is the need for pre-corrugated product to be produced in large volumes before the lamination stage can be completed. Corrugated card must be initially formed then allowed to cool and cure for a significant period of time before it can be laminated. This in effect makes the creation of such corrugated metal-lined products a slow two stage process.

The applicant has determined that significant heat dissipation problems occur during the application of a continuous sheet of a metalized film to a corrugated card or substrate when trying to use existing lamination technologies to laminate a corrugated product immediately after it exits a set of corrugation rollers. More particularly, a significant amount of heat is present in the corrugated card or substrate as it exits the corrugation rollers. This high level of heat causes complications during the application of a layer of metalized film to one or both sides of the corrugated substrate due to the derogatory effects such heat level has on the adhesive traditionally used to unite the metalized film to the corrugated substrate. Indeed, the heat problems are magnified by the metallization of the laminate since the metal layer reflects, absorbs and re-radiates heat into the corrugated substrate or card as the adhesive bonds.

It is the applicant's contention that to date these heat dissipation problems have prevented the development of a manufacturing process and associated machinery which could produce metalized corrugated product once passed through the lamination of a metalized liner as a resulting product as the corrugated card exits the set of corrugation rollers.

Reference is also made in the Olvey specification to the provision of a corona treatment to the plastics laminate film which is to be applied to pre-corrugated card products. As the card to be laminated has been pre-corrugated it has had a chance to cool down and cure after the corrugation process. The corona treatment applied or used with the film to be laminated is therefore provided to improve the adhesive qualities of the film to the pre-made corrugated card product.

An improved method of forming a metalized liner onto a corrugated product which addressed any or all of the above problems would be of advantage.

It is an object of the present invention to provide a method and apparatus for producing insulated containers with corrugated board as a core material.

Further aspects and advantages of the present invention will become apparent from the ensuing description which is given by way of example only.

### BRIEF SUMMARY

According to one aspect of the present invention there is provided a method of forming a laminated material on a continuous basis comprising the steps of:

(a) corrugating a paper sheet at a temperature of approximately 130° C. to approximately 170° C.; and,

(b) within approximately 5 minutes of formation of the corrugated paper sheet, applying a liner laminate to one side of the corrugated paper sheet on a continuous basis; and,

the liner laminate comprising a substrate paper layer, a metalized layer and a polyester film which is on the exterior of the laminated material; and,

the polyester having a melting point of approximately 120° C. before a pre-treatment; and,

opposed sides which are each pre-treated from one of a chemical treatment and a corona treatment; the pre-treatment of the sides of the polyester film being adapted to impart an increased melting point and increased adhesion properties to the polyester film.

According to a further aspect of the present invention there is provided a method of forming a laminated material on a continuous basis comprising the steps of:

(a) corrugating a paper sheet at a temperature of approximately 130° C. to approximately 170° C. and,

(b) within approximately 5 minutes of formation of the corrugated paper sheet, applying a liner laminate to one side of the corrugated paper sheet on a continuous basis;

the liner laminate comprising a substrate paper layer, a metalized layer and a polyester film which is on the exterior of the laminated material; and,

opposed sides which are each pre-treated from one of a chemical treatment and a corona treatment; the pre-treatment of the sides of the polyester film being adapted to impart an altered surface tension to the liner laminate allowing residual heat to dissipate more uniformly.

According to a yet further aspect of the present invention, there is provided a method of forming a laminated material on a continuous basis comprising the steps of:

(a) corrugating a paper sheet at a temperature of approximately 130° C. to approximately 170° C. and,

(b) within approximately 5 minutes of formation of the corrugated paper sheet, applying a liner laminate to one side of the corrugated paper sheet on a continuous basis;

the liner laminate comprising a substrate paper layer, a metalized layer and a polyester film which is on the exterior of the laminated material; and,

opposed sides which are each pre-treated from one of a chemical treatment and a corona treatment; the pre-treatment of the sides of the polyester film being adapted to impart increased adhesion properties to the polyester film.

Preferably, the corrugated paper sheet and the liner laminate are applied to each other within approximately 60 seconds of the formation of the corrugated paper sheet.

In one embodiment, chemical treatment of the polyester film is completed using an acrylic spray.

Preferably, the polyester film is a bi-axially oriented metalized polyester film.

Preferably, the liner laminate is preheated prior to its application to the corrugated paper sheet.

Preferably, the liner laminate is heated by heating rollers and adhered to the corrugated paper sheet using a corrugation adhesive.

Preferably, the liner laminate is laminated to one side of the corrugated paper sheet as the paper sheet is fed from a series of corrugating rollers.

The apparatus may include means for feeding a second liner for lamination with the corrugated paper sheet.

The lamination of the corrugated paper sheet and liner with the second liner can be subsequent to the lamination of the corrugated paper sheet with the liner laminate.

The lamination of the corrugated paper sheet and the liner laminate with the second liner laminate can be achieved with the assistance of a cluster of in-line pressure rollers.

The second liner laminate can be a laminate of a plastics film and a paper substrate.

The paper substrate used to form the liner laminate can be of various thicknesses and grades and within the definition of paper it is intended to include thicker semi-rigid paper sheets (cardboard) and recycled and composite sheet materials including cellulose fibers derived from a variety of materials.

In this instance the novelty of the invention revolves around corona or chemical treatment of the polyester film. The inventor found that heat dissipation problems exist with the application of a continuous sheet of metalized polyester film using existing technology. A significant amount of heat is present in the corrugated paper as it exits the corrugation rollers, which in combination with applying a layer of metal to one side of the card causes complications in the performance of an adhesive used to unite the two components. By corona or chemically treating the polyester film these heat problems are alleviated.

A major advantage of the present invention comes from manufacturing speed increases obtained through corrugating card product and applying the metalized layer at approximately the same time i.e. continuous processing. With prior art metalized corrugated products, the metalized layer is typically applied after the source card has been corrugated and heat cooled. This is commonly known as sheet laminating which is in effect a batch process.

The present invention provides significant manufacturing advantages prior art methods as it allows the application of a liner at the same time as the paper sheet is corrugated. This significantly speeds up and simplifies the manufacturing process which is normally a two step operation. Newly corrugated paper sheet must normally be allowed to cool before the liner can be applied.

The essence of the present invention relies on the particular characteristics of the film used in the manufacture of the metalized corrugated product.

The use of corona or chemical treated polyester film ensures that the present invention can be used to produce the metalized corrugated product as the base corrugated material exits a set of corrugation rollers. Metallization of such a corrugated product can cause additional complications in the glue or adhesive used to unite the liner and the paper sheet together, in combination with heat generated through corrugation, which is solved by the use of the corona and/or chemical treated polyester film.

With the applicant's invention, the addition of corona or chemical treatment to the polyester film eliminates these concerns. The liner may be applied while or immediately subsequent to the emergence of the corrugated paper sheet from a set of corrugation rollers even when still at elevated temperatures from corrugating of between 130° C. to 170° C.

The applicant has determined that by corona treating one side of the polyester film of the liner applied to the corrugated paper sheet, these heat problems, including the heat magnification problem, are alleviated. It is envisaged that this may be because the polyester film, through pre-treatment effectively has the melting temperature increased from typical levels of approximately 120° C.

Furthermore, the applicants have also found that the chemically treated polyester film can be used to produce the metalized corrugated product required, again as the base corrugated material exits the set of corrugation rollers. Chemically treated polyester film again ensures that heat complications arising from the glue or adhesive used to unite the liner and the paper sheet together are solved.

Chemically treated polyester film is normally employed to improve the adhesive and printing qualities of laminated products. However, the applicants have found that this type of chemically treated film also aids in solving the heat problems (including the heat magnification problems) associated with lamination of a base corrugated material as it exits the set of corrugation rollers.

One aspect found was that chemically treating the polyester film changes the surface tension of the plastic film in a similar manner to an etching process.

In a preferred embodiment the film employed may be chemically treated through having an acrylic coating applied to it. This acrylic coating gives the film the required characteristics to allow it to function effectively in accordance with some embodiments of the present invention.

Preferably, the polyester film is either corona and/or chemically treated on both sides.

### BRIEF DESCRIPTION OF THE DRAWINGS

Aspects of the present invention will be described in relation to the accompanying drawing in which

FIG. 1 shows a schematic side view of apparatus in accordance with the present invention set up to produce a two or three ply laminate; and

FIG. 2 shows a schematic exploded side view of the laminated material.

### DETAILED DESCRIPTION

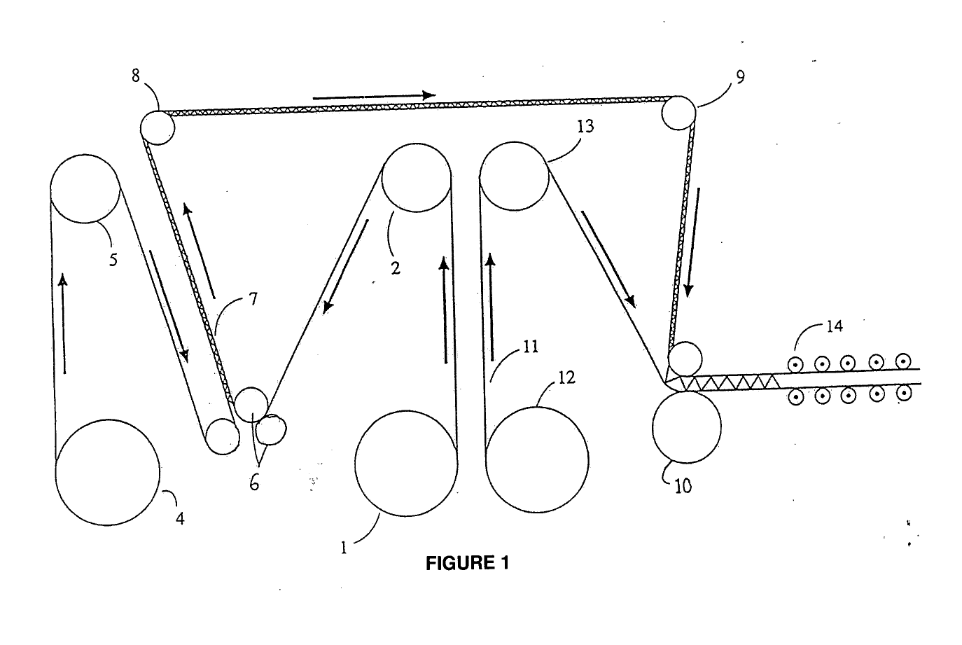

With reference to FIG. 1, a roll of paper to be corrugated 1 is threaded over a heating roller 2 and fed to corrugating rollers 6. It should be appreciated that the paper for corrugation may be of varying grades of thickness and density and may be referred to as cardboard. This should not be seen as limiting.

Simultaneously a liner laminate is fed from a roll 4 over a pre-heating roller 5 to the corrugating rollers 6 and laminated to one side of corrugated paper 7 as it leaves the corrugator rollers. As can be appreciated by those skilled in the art, the liner laminate is united with the corrugated paper 1 as the paper is corrugated and exits the corrugation rollers 6. It is the inventor's experience that ideally, the liner laminate is laminated to the corrugated paper within approximately 5 minutes, more preferably, almost immediately after corrugation or at least within 60 seconds of corrugation. It is understood that this assists in creating a uniform finish and has the added advantage of allowing for continuous processing.

The laminar is next fed via rollers 8, 9 to nip rollers 10, where (optionally) a laminate liner 11 from a roll 12 is fed via pre-heating roller 13 to the nip rollers 10 to provide a lining to the other side of the corrugated paper.

A cluster of crushing and heating rollers 14 are positioned downstream of the nip rollers 10 through which the completed laminated material is fed. Downstream of the lamination apparatus the completed laminated material is stored and cured prior to cutting into box blanks. Containers can be erected from the box blanks.

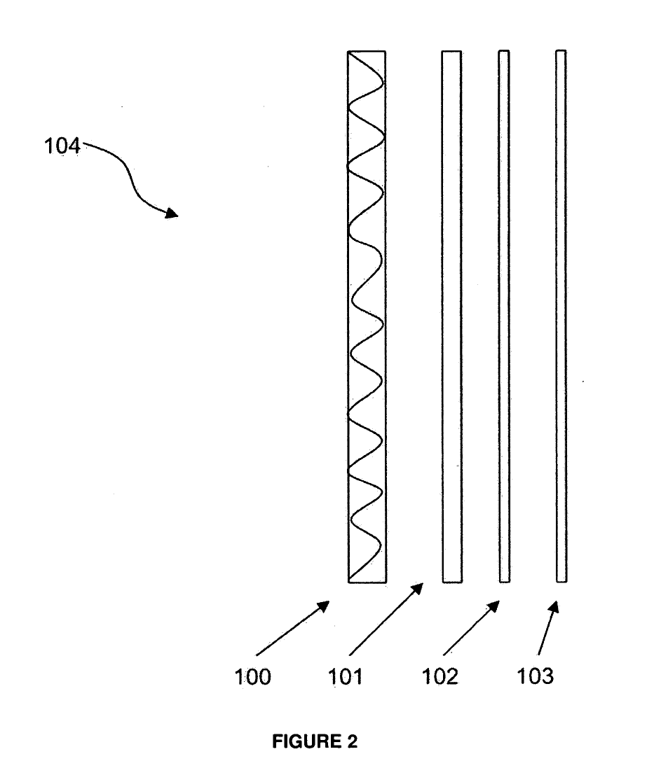

Referring to FIG. 2, the paper to be corrugated 100 may be selected from a range of Kraft™ and recycled papers.

The liner laminate (collectively 104) is comprised of three layers being a substrate paper layer 101, a metalized layer 102 and a polyester film layer 103.

The polyester film 103 used preferably has high gas barrier properties, high reflectivity to light and radiant heat, low permeability to gases and water vapor, it is attractive and decorative, exhibits good abrasion resistance and can be characterized or specified as:
1. Thickness, 12 Micron
2. Tensile strength, 29 kg/mm²
3. Tear strength 7 MD
4. Coefficient of friction 0.6 (film to film)
5. WVTR g/m²/24 hr=2.0

Typically the polyester film 103 has a normal melting point of approximately 100° C. to approximately 140° C. before corona and/or chemical treatment.

The process of laminating the liner laminate 104 to the corrugated paper 100 is a reel to reel process using PVA adhesive, applied at normal room temperature at approximately 70 meters per minute.

The metalized side of the finished laminated product can be threaded over the pre-heaters with the metalized side facing outwards or inwards (this avoids any likelihood of scuffing the metalized surface). Care must be taken to avoid scuffing if the inwards method is used.

An ideal corrugating speed is between 90 and 120 meters per minute.

At normal corrugating temperatures (130° C.-170° C.) the finished laminated material retains heat for some time due to the metalized layer. During this time, care must be taken when handling the product.

The converting process (making of a finished box) cannot take place until 24 hours after corrugating. This time is necessary for the curing process i.e. cooling of the completed laminate and the moisture balance to finalize.

Whilst it has been known to laminate sheet material such as cardboard with plastics film in the past, this has never been done using a corrugator on a continuous basis. Despite advice to the contrary the inventor has found that this is possible, the key factor being the pre-made liner laminate 104. The paper substrate layer 101 acts as a backing on the liner laminate 104 that resists stretching and minimizes the distribution of heat during the laminating process. It is also understood that the pre-treatment alters the melting point of the polyester and/or increases the adhesion properties of the polyester film 103 to the metalized layer 102.

The liner laminate 104 is preferably formed by either corona or chemically treating both opposing sides of a polyester film 103, and laminating the treated film 103 on one side to a metal layer 102. The metal layer 102, preferably a thin aluminum layer, is in turn laminated to a substrate paper layer 101.

Table 1 shows the physical properties of two different types of chemically treated metalized polyester film. The first product is a one-side metalized polyester film which is chemically treated on both sides and is marketed by Rexam Metalizing of Australia under the trade mark Melinex 845™. The second product shown is a metalized polyester film, which is chemically treated only on the unmetallized side of the film. This product is again manufactured by Rexam Metalizing of Australia under the product name Melinex 813™.

TABLE 1

| PHYSICAL | | | |
|---|---|---|---|
| PROPERTIES | UNITS | MELINEX 845 | MELINEX 813 |
| THICKNESS | microns | 12 | 12 |
| BASIS WEIGHT | g/m² | 16.8 | 16.8 |
| TENSILE | kg/mm² | 20 | >17.5 |
| STRENGTH | | 26 | >17.5 |
| BREAKING | % | 125 | 125 |
| ELONGATION | | 80 | 80 |
| COF | — | 0.50 | 0.50 |
| METAL BOND | g/25 mm | >600 | |
| | | destructive bond | |
| OPTICAL DENSITY | — | 2.2-2.8 | 2.2-2.8 |
| OXYGEN | cc/m²/day | <1.0 | 0.5 |
| TRANSMISSION | | | |
| 23° C. & 50% RH | | | |
| MOISTURE | g/m²/day | <1.0 | 0.5 |
| TRANSMISSION | | | |
| 38° C. & 90% RH | | | |

Table 2 shows the physical properties of two further different types of chemically treated polyester film. Both of these films are manufactured by Saehan Industries of South Korea. The first of these products, MP-531 is a metalized polyester film, while the second of these products, XP-131 is the base chemically treated polyester film material used in MP-531 before a metal layer is added.

TABLE 2

| PROPERTIES | UNITS | MP-531 | XP131 |
|---|---|---|---|
| THICKNESS | μm | 12.02 | 16 |
| TENSILE | kg/mm² | 25.9 | 26 |
| STRENGTH, MD | | | |
| TENSILE | % | 26.0 | 25 |
| STRENGTH, TD | | | |
| ELONGATION | % | 137 | 135 |
| AT BREAK, MD | | | |
| ELONGATION | % | 142 | 135 |
| AT BREAK, TD | | | |
| HEAT | % | 1.50 | 1.4 |
| SHRINKAGE, MD | | | |
| HEAT | % | −0.20 | 0.3 |
| SHRINKAGE, TD | | | |
| HAZE | % | 3.8 | 3.8 |
| TOTAL | % | 89.9 | 89.6 |
| LUMINOUS | | | |
| TRANSMISSION | | | |

Aspects of the present invention have been described by way of example only and it should be appreciated that modifications and additions may be made thereto without departing from the scope thereof as defined in the appended claims.

What is claimed is:

1. A method of forming a laminated material on a continuous basis comprising the steps of:
(a) corrugating a paper sheet at a temperature of approximately 130° C. to approximately 170° C. and,
(b) within approximately 5 minutes of formation of the corrugated paper sheet, applying a liner laminate to one side of the corrugated paper sheet on a continuous basis;
the liner laminate comprising a substrate paper layer, a metalized layer and a polyester film which is on the exterior of the laminated material; and,
opposed sides which are each pre-treated from one of a chemical treatment and a corona treatment; the pre-treatment of the sides of the polyester film being adapted to impart an increased melting point and increased adhesion properties to the polyester film.

2. The method of claim 1 wherein the corrugated paper sheet and the liner laminate are applied to each other within approximately 60 seconds of the formation of the corrugated paper sheet.

3. The method of claim 1 wherein the polyester film is a bi-axially oriented metalized polyester film.

4. The method of claim 1 wherein the liner laminate is preheated prior to its application to the corrugated paper sheet.

5. The method of claim 1 wherein the liner laminate is heated by heating rollers and adhered to the corrugated paper sheet using a corrugation adhesive.

6. The method of claim 1 wherein the liner laminate is laminated to one side of the corrugated paper sheet as the corrugated paper sheet is fed from a series of corrugating rollers.

7. The method of claim 1 wherein the polyester film used has a melting point of approximately 120° C. before chemical or corona treatment.

8. A method of forming a laminated material on a continuous basis comprising the steps of:
(a) corrugating a paper sheet at a temperature of approximately 130° C. to approximately 170° C. and,
(b) within approximately 5 minutes of formation of the corrugated paper sheet, applying a liner laminate to one side of the corrugated paper sheet on a continuous basis;
the liner laminate comprising a substrate paper layer, a metalized layer and a polyester film which is on the exterior of the laminated material; and,
opposed sides which are each pre-treated from one of a chemical treatment and a corona treatment; the pre-treatment of the sides of the polyester film being adapted to impart an altered surface tension to the liner laminate allowing residual heat to dissipate more uniformly.

9. A method of forming a laminated material on a continuous basis comprising the steps of:
(a) corrugating a paper sheet at a temperature of approximately 130° C. to approximately 170° C. and,
(b) within approximately 5 minutes of formation of the corrugated paper sheet, applying a liner laminate to one side of the corrugated paper sheet on a continuous basis;
the liner laminate comprising a substrate paper layer, a metalized layer and a polyester film which is on the exterior of the laminated material; and,
opposed sides which are each pre-treated from one of a chemical treatment and a corona treatment; the pre-treatment of the sides of the polyester film being adapted to impart increased adhesion properties to the polyester film.
